(19) United States
(12) Patent Application Publication
(10) Pub. No.: US 2017/0257012 A1
(43) Pub. Date: Sep. 7, 2017

(54) STATOR WHICH PERMITS GOOD WEDGE SUPPORT WHILST OPTIMISING THE MAGNETIC CIRCUIT, AND METHOD FOR ELECTRICAL INSULATION OF THE SAID STATOR

(71) Applicant: VALEO EQUIPEMENTS ELECTRIQUES MOTEUR, Creteil Cedex (FR)

(72) Inventors: Vincent RAMET, Etaples (FR); Stéphane DE CLERCQ, Rang du Fliers (FR); Eric MAQUINGHEN, Bernieulles (FR)

(21) Appl. No.: 15/503,918

(22) PCT Filed: Sep. 2, 2015
(86) PCT No.: PCT/FR2015/052320

§ 371 Date: Feb. 14, 2017

(30) Foreign Application Priority Data
Sep. 12, 2014 (FR) 1458570

(51) Int. Cl. H02K 15/12; F02N 11/00; H02K 3/487; H02K 15/10; H02K 3/34

(52) U.S. Cl. CPC H02K 15/12; H02K 15/10; H02K 3/345; H02K 3/487; F02N 11/00; H02K 2213/03

(57) ABSTRACT

The invention relates to a stator consisting of a plurality of metal sheets (1a, 1b, 1c, . . . , 1n) forming a generally cylindrical packet of metal sheets (1), the stator having a plurality of radial notches (2), each being delimited by two adjacent teeth (3) extending radially and being connected to one another by the proximal end (3A) thereof, the distal ends (3B) thereof defining a cylindrical axial recess capable of receiving a rotor and being provided with tooth roots (4), an insulator (5) for insulating the bottom of the notch which is provided inside the notches and covers the inner wall of the notches along the useful boundary for receiving conductive wires (F), the stator further comprising a plurality of flat shims (6) for closing the notches, wherein each notch-closing shim is arranged inside a notch, at a distance greater than zero from the lower end of the notch-bottom insulator.

The present invention relates to a stator of an alternator, an alternator-starter or a rotary electrical machine for a motor vehicle.

A stator is generally constituted by a plurality of plates forming a set of plates with a cylindrical form with radial notches, each notch being delimited by two adjacent teeth which are connected to one another by means of their proximal end. The teeth extend radially, and their distal ends define a cylindrical axial receptacle delimited by an inner surface which can receive a rotor. The distal end of each of the teeth has tooth roots constituted by projecting portions extending in the direction of the inner cavity of the notches, such as to reduce the width of the notch at its inlet.

The notches are provided in their interior with a notch base insulator which covers the inner wall of the said notches on the useful filling periphery of the conductive wires. This insulator has a cross-section in the form of a “U”, the lateral branches of which are placed against the radial walls of the two adjacent teeth delimiting a notch, up to the level of the upper ends of the tooth roots.

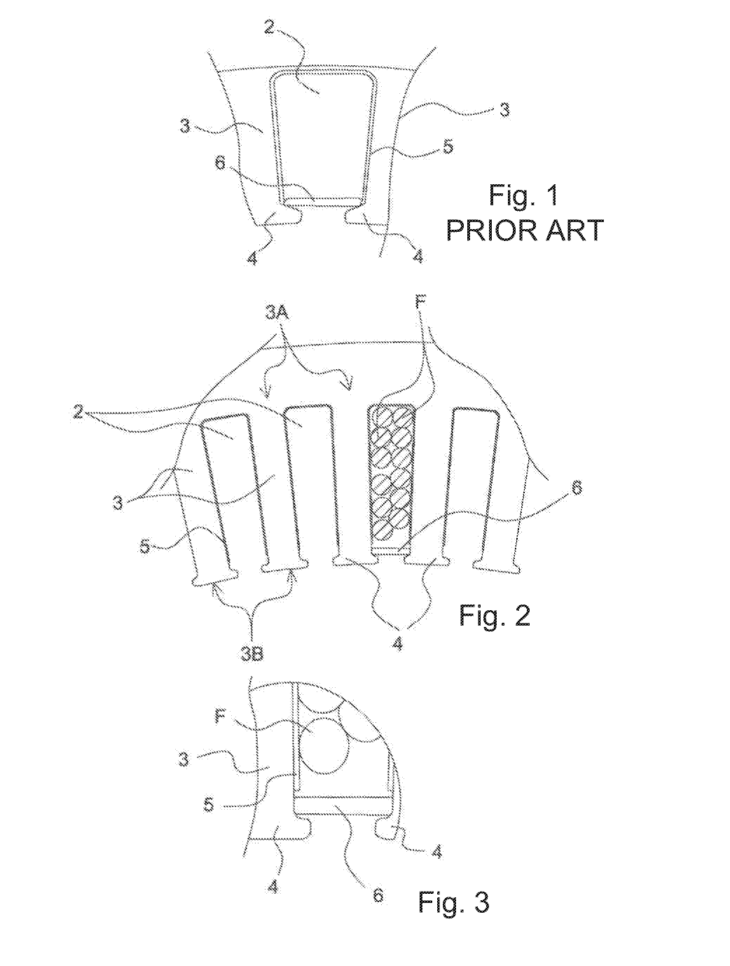

It is common to use a wedging technology, constituted for example by flat wedges, in order to retain the conductive wires inside the notches, these wedges also providing dielectric protection. These notch closure wedges are placed inside the notch, and are generally supported on the tooth roots, between the lateral branches of the insulator (see FIG. 1), thus providing a wedge support (WS) which depends on the notch inlet width, the width of the tooth root and the thickness of the insulator. It is accepted that for good mechanical retention of the wedge in the notch, the value of this support must be equal to 0.4 mm or more.

In order to optimise the magnetic circuit of an alternator, i.e. in order to make it possible to transfer a greater quantity of magnetic flux from the rotor to the stator of an alternator, and avoid saturation of magnetic flux, it has been envisaged to increase the thickness of the teeth. This solution has the major disadvantage of giving rise to a decrease in the dimensions of the tooth roots, and consequently to a decrease of the wedge support.

In order to counter this decrease in support, it could be envisaged to increase the dimensions of the tooth roots, simultaneously with the increase in the thickness of the teeth.

However this solution has its limits, since the increase in the dimensions of the tooth roots gives rise to a decrease in the notch inlet opening, whereas these stators are designed for radial insertion of continuous conductive wires in the notches, such that the notch inlet opening cannot be made smaller than the width of the conductive wire.

An objective of the present invention is to provide a stator which makes it possible to optimise the magnetic circuit, whilst maintaining a wedge support which permits good mechanical retention inside the notch.

According to the invention, this objective is obtained by means of a stator, in particular of a rotary electrical machine for a motor vehicle, constituted by a plurality of plates forming a set of plates with a generally cylindrical form, the said stator having a plurality of radial notches, each notch being delimited by two adjacent teeth which extend radially, and are connected to one another by means of their proximal end, their distal ends defining a cylindrical axial receptacle which can receive a rotor, and being provided with tooth roots constituted by projecting portions extending in the direction of the inner cavity of the notches, such as to reduce the width of the notch at its inlet, the notches being provided in their interior with a notch base insulator covering the inner wall of the said notches on the useful filling periphery of the conductive wires, and the stator comprising a plurality of flat notch closure wedges, this stator being distinguished in that each notch closure wedge is arranged inside the notch, at a non-zero distance from the lower end of the notch base insulator. In other words, a radial space can be defined between the closure wedge and the notch base insulator.

Each notch closure wedge is then directly in contact with the set of plates, and is therefore no longer in contact with the corresponding notch base insulator, as was the case in the prior art. The closure wedge is retained in position by the respective tooth roots of the notch in which the wedge is inserted. The thickness of each tooth can then be increased by at least twice the width of the notch base insulator, in particular at the distal end of the tooth (i.e. the end close to the notch opening), without decreasing the support of the wedge and without decreasing the opening of the notch.

The stator thus produced permits optimisation of the magnetic circuit by increasing the quantity of magnetic flux transmitted, by means of the increase in the thickness of the tooth, whilst decreasing the saturation of the stator, and it provides the notch closure wedge with good support. In addition, the fact of guaranteeing that the wedge has good support makes it possible to use only a flat wedge in order to retain the conductive wires inside the notch, without adding additional devices which would reduce the notch surface and would increase the production costs of a stator of this type.

According to a particularly advantageous embodiment applied to a stator not saturated with magnetic flux, the lower part of each of the teeth has a groove which extends axially along the stator, between the lower end of the insulator and the upper end of the tooth roots.

The stator thus produced makes it possible to improve further the support of the notch closure wedge.

According to another characteristic arrangement, the distance which separates the upper end of the notch closure wedge and the lower end of the notch base insulator is between 0.05 mm and 0.6 mm.

According to a preferred and advantageous embodiment, the surface of the stator constituted by the inner surface which delimits the axial receptacle of the associated rotor and the outer surfaces of the first and last plates which constitute the set of plates is covered with an insulating coating.

At present, the main technique used in the industry which makes it possible to cover a stator with an insulating coating consists of spraying the insulating coating by means of known spray gun devices, orienting the jet of insulating coating perpendicularly to the inner surface of the stator.

However, this technique has the major disadvantage of leaving non-painted shaded areas, in particular on the outer surfaces (surfaces opposite the coil chignons) of the first and last plates which constitute the set of plates (see FIG. 6).

In order to ensure complete coating of the stator, it is known to immerse the set of plates which constitutes the said stator in a cataphoresis bath. However this method is very costly.

The present invention thus also relates to a method for simple and economical electrical insulation of a stator with one or more of the aforementioned characteristics.

According to the invention, this objective is achieved by means of a method for electrical insulation of a stator, the stator being constituted by a plurality of plates forming a set of plates with a generally cylindrical form, and the said stator having a plurality of radial notches, each notch being delimited by two adjacent teeth extending radially, and being connected to one another by means of their proximal end, their distal ends defining a cylindrical axial receptacle which can receive a rotor, and being provided with tooth roots constituted by projecting portions extending in the direction of the inner cavity of the notches such as to reduce the width of the notch at its inlet, the said method being distinguished in that it comprises:
a step of insertion of a notch base insulator in the notches, such as to cover the inner wall of the said notches on the useful filling periphery of the conductive wires;
a step of putting into place a plurality of flat notch closure wedges, each notch closure wedge being arranged inside a notch, at a non-zero distance from the lower end of the notch base insulator.

This method for electrical insulation makes it possible to insulate the conductive wires of the set of plates electrically, efficiently and inexpensively, whilst ensuring the retention of the said conductive wires inside the notch. In particular, this method for electrical insulation makes it possible to insulate the conductive wires of the set of plates electrically at the useful filling periphery of the conductive wires. Useful filling periphery means the base of the notch, as well as the two lateral surfaces of the notch which extend opposite one another, and on which the conductive wires are placed.

According to an advantageous embodiment, the insulation method has a step of depositing an insulating coating on the surface of the stator constituted by the inner surface which delimits the axial receptacle of the associated rotor and the outer surfaces of the first and last plates which constitute the set of plates, such as to make up for the lack of insulation between the wedge and the notch base insulator. In other words, the step of depositing the insulating coating is carried out such that the said deposit forms a layer of electrical insulation between the conductive wires and the set of plates, which layer is positioned at least at each radial space defined between the closure wedge and the notch base insulator.

This embodiment of the insulation method makes it possible to provide anti-corrosion protection for the stator, and better electrical insulation between the conductive wires and the set of plates, at the notch inlets and on the first and last plates which constitute the set of plates.

According to a preferred and advantageous embodiment of the method for insulation according to the invention, the method comprises a step of spraying an insulating coating constituted by an insulating paint of the organic resin type with good dielectric power, by means of a known spraying device, which is designed to permit spraying of the said insulating coating on all of the surface of the stator constituted by the inner surface which delimits the axial receptacle of the associated rotor and the outer surfaces of the first and last plates which constitute the set of plates.

According to an advantageous embodiment, the method comprises a step of spraying the insulating coating by means of a known spray gun device secured on the end of an articulated arm, which makes it possible to displace the spray nozzle of the spray gun device opposite each of the surfaces of the stator constituted by the inner surface which delimits the axial receptacle of the associated rotor and the outer surfaces of the first and last plates which constitute the set of plates.

According to an advantageous form of execution, the method comprises a step of spraying the insulating coating by means of two fixed spray nozzles oriented such that their combined action covers all of the surface of the stator constituted by the inner surface delimiting the axial receptacle of the associated rotor and the outer surfaces of the first and last plates which constitute the set of plates.

The present invention also relates to a rotary electrical machine comprising a stator as previously described. According to one embodiment, the said rotary electrical machine can form an alternator or an alternator-starter.

The above objectives, characteristics and advantages, and also others, will become more apparent from the following detailed description and the appended drawings in which:

FIG. 1 is a detailed schematic view illustrating a stator notch according to the prior art.

FIG. 2 is a partial view of a first embodiment of the stator according to the invention.

FIG. 3 is a detailed view on an enlarged scale of a notch inlet of the stator according to FIG. 2.

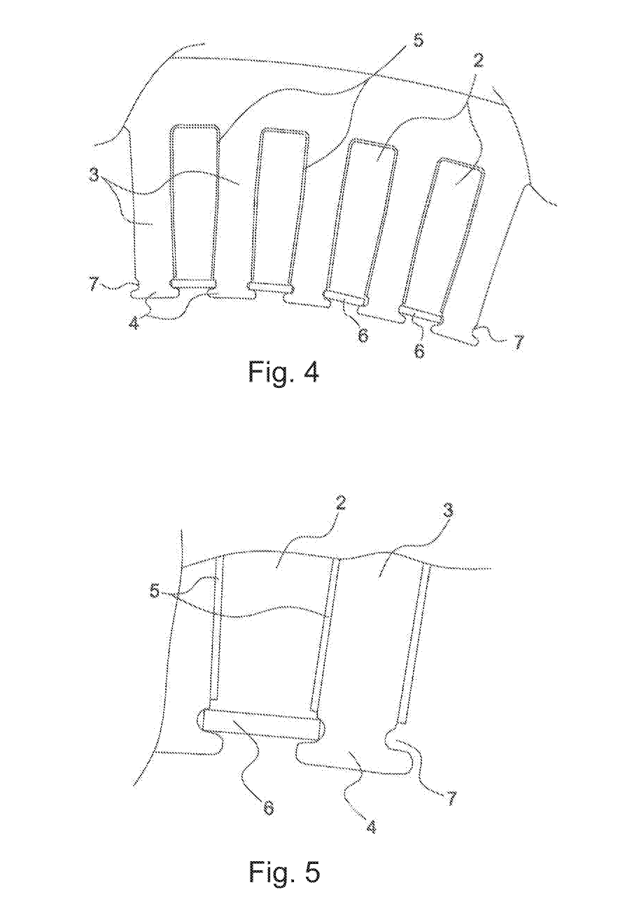

FIG. 4 is a partial view of a second embodiment of the stator according to the invention.

FIG. 5 is a detailed view on an enlarged scale of a notch inlet of the stator according to FIG. 4.

FIG. 6 is a schematic view illustrating the method for depositing an insulating coating, as carried out at present.

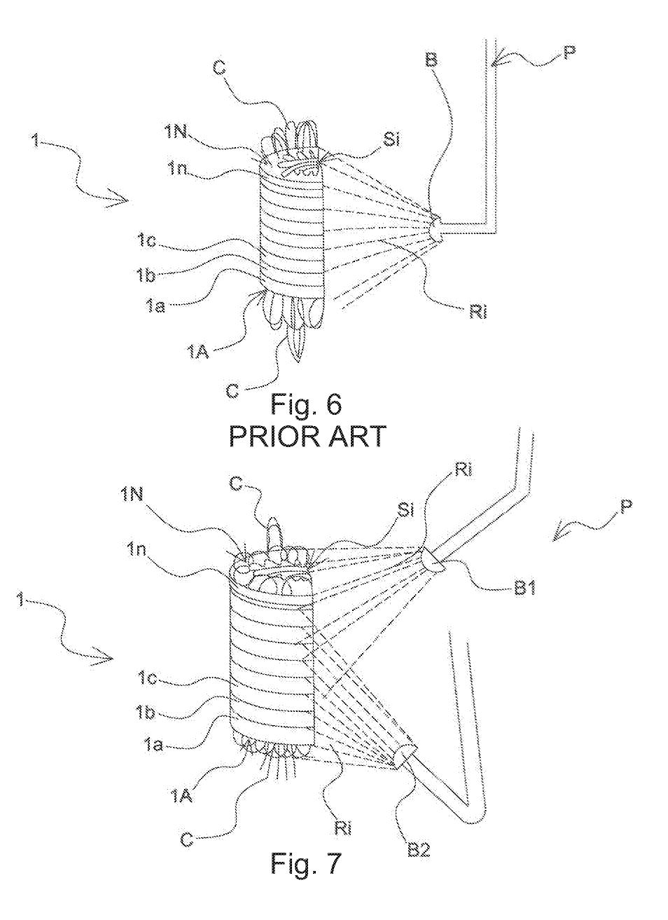

FIG. 7 is a schematic view illustrating the method for depositing an insulating coating according to the invention.

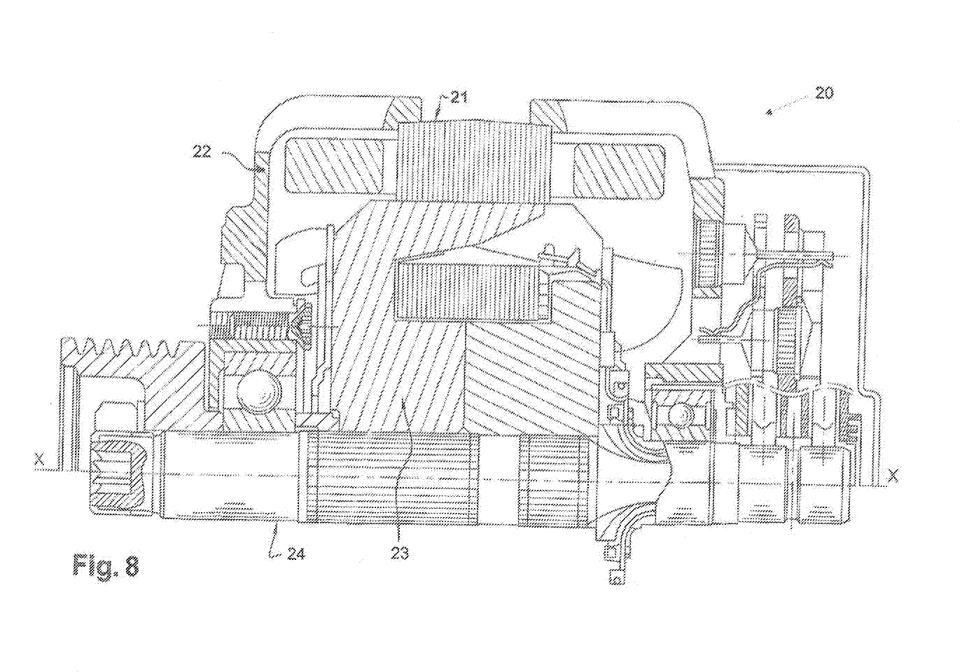

FIG. 8 is a schematic view in cross-section illustrating partially a rotary electrical machine according to an embodiment of the present invention.

Reference is made to the said drawings in order to describe examples which are advantageous, although in no way limiting, for production of the stator, and of the method for depositing an insulating coating according to the invention.

In the present description and in the claims, according to a direction which is radial relative to an axis X of rotation of the rotary electrical machine, the words “proximal” and “upper” designate elements which are close to the outer periphery of the stator, i.e. closer to the housing, whereas the words “distal” and “lower” designate elements which are close to the inner periphery of the stator, i.e. closer to the rotor.

The stator 21 according to the invention is constituted by a plurality of plates 1a, 1b, 1c, . . . , 1n, forming a set of plates 1 with a generally cylindrical form, this stator having a plurality of radial notches 2, each notch being delimited by two adjacent teeth 3 extending radially and being connected to one another by means of their proximal end 3A, their distal ends 3B defining a cylindrical axial receptacle which can receive a rotor (not represented), and the teeth are provided with tooth roots 4 constituted by projecting portions extending in the direction of the inner cavity of the notches 2, such as to reduce the width of the notch at its inlet, the notches being provided in their interior with a notch base insulator 5 which covers the inner wall of the said notches on the useful filling periphery of the conductive wires F.

Each distal end of a tooth 3 thus comprises a tooth root 4 constituted by a portion extending projecting from the said distal end towards the inside of the notch 2, i.e. towards another distal end of a tooth adjacent to the said tooth 3. In other words, if a tooth 3 provided with two flat surfaces extending radially is taken into consideration for example, each of the two projecting portions is intersected substantially perpendicularly by the said flat surface of the corresponding tooth 3. In this case, each notch 2 thus has a distal opening opposite the rotor. This opening is delimited by two tooth roots 4 associated respectively with two adjacent teeth 3 which delimit the notch 2.

Each notch comprises at least one conductive wire F, and preferably a plurality of conductive wires F, with all of these conductive wires F forming a winding of the stator. The useful filling periphery of the conductive wires is defined as the surface of the notch 2 on which the conductive wires F extend.

The notch base insulator 5 thus extends at least between the conductive wires F and the set of plates 1, such that the conductive wires F are spaced from the set of plates 1, in other words, such that the conductive wires F are no longer in electrical contact with the set of plates 1. In particular, the insulator 5 does not cover all of the radial walls of the notch 2, but only part of the said walls. In this embodiment, the insulator 5 has a cross-section in the form of a “U”, the base of which is placed against the notch base 2, and the lateral branches of which are placed respectively against the radial walls of two adjacent teeth 3 opposite one another, these lateral branches not extending as far as the distal end of the said teeth 3.

This stator comprises a plurality of flat notch closure wedges 6 which make it possible to retain the winding inside each of the notches. The flat wedges are made of a single-layer or three-layer composite material. For example, the notch closure wedges are made of polyetheretherketone (PEEK) or of a three-layer polyethyleneterephthalate (PET) compound such as Dacron (registered trademark)/Mylar (registered trademark)/Dacron (registered trademark) (DMD).

According to the embodiment illustrated in FIGS. 2 and 3, each notch closure wedge 6 is arranged inside a notch 2, at a non-zero distance from the lower end of the notch base insulator 5. For example, the distance which separates the upper end of the notch closure wedge and the lower end of the notch base insulator is between 0.05 mm and 0.6 mm. In addition, each wedge 6 is retained by two tooth roots 4 opposite one another. The tooth roots also make it possible to optimise the quantity of magnetic flux transmitted from the rotor to the stator or conversely.

This configuration makes it possible to retain good support of the notch closure wedge on the tooth roots 4, whilst increasing the thickness of the teeth 3 by a distance equivalent to twice the thickness of the notch base insulator 5.

According to the embodiment represented in FIGS. 4 and 5, the lower part of each of the teeth 3 has a groove 7 which extends axially along the stator, between the lower end of the notch base insulator 5 and the upper end of the tooth roots 4.

This configuration applies particularly to a stator which is not saturated with magnetic flux, and makes it possible to improve further the support of the notch closure wedge.

Preferably and advantageously, the surface of the stator which is constituted by the inner surface SI delimiting the axial receptacle of the associated rotor and the outer surfaces S1A, S1N respectively of the first and last plates 1a, 1n which constitute the set of plates 1 is covered with an insulating coating.

The invention also relates to a method for electrical insulation of a stator as previously described. This method comprises a step of insertion of a notch base insulator 5 in the notches, such as to cover the inner wall of the said notches on the useful filling perimeter of the conductive wires F, and a step of putting a plurality of flat notch closure wedges 6 into place, each notch closure wedge being arranged inside a notch at a non-zero distance from the lower end of the notch base insulator.

The configuration according to which the flat wedge 6 is positioned in the notch 2 at a non-zero distance from the lower end of the insulator 5 induces a gap between the insulator and the said flat wedge, and consequently an electrical insulation fault between the conductive wires F and the set of plates 1. Under the effect of corrosion, salt water spray, or condensation on conductive minerals, this insulation fault at the notch inlets can however give rise to the creation of an electric bridge, thus generating current leakages between the damaged parts which may exist on the enamel of the conductive wires F, and portions of the plates which are not covered with the notch base insulator can give rise to earthing of the stator.

In order to eliminate this disadvantage, the objective is to add a layer of insulation on the conductive wires F and on the set of plates 1 in order to prevent the establishment of detrimental electrical conductivity of this type.

According to the method of the invention, an insulating coating RI is deposited on the surface of the stator constituted by the inner surface SI which delimits the axial receptacle of the associated rotor and the outer surfaces S1A, S1N respectively of the first and last plates 1a, 1n which constitute the set of plates 1.

This method makes it possible to make up for the insulation fault constituted by the gap which exists between the notch base insulator 5 and the notch closure wedge 6, and to obtain both anti-corrosion protection of the plate of the stator and also insulation between the copper of the conductive wires F of the winding and the iron of the set of plates 1.

According to a preferred and advantageous embodiment of the method for insulation according to the invention, an insulating coating RI is sprayed, constituted by insulating paint of the organic resin type with good dielectric power, by means of a known spraying device P which is designed to permit spraying of the said insulating coating on all of the surface of the stator constituted by the inner surface SI which delimits the axial receptacle of the associated rotor (not represented) and the outer surfaces S1A, S1N respectively of the first and last plates 1a, 1n which constitute the set of plates 1.

According to a first embodiment not represented, the insulating coating RI is sprayed by means of a known spray gun device secured on the end of an articulated arm which makes it possible to displace the spray nozzle B of the spray gun device opposite each of the surfaces of the stator constituted by the inner surface SI which delimits the axial receptacle of the associated rotor and the outer surfaces S1A, S1N respectively of the first and last plates 1a, 1n which constitute the set of plates 1.

According to the example of execution illustrated in FIG. 7, the insulating coating is sprayed by means of two fixed spray nozzles B1, B2 which are oriented such that their combined action covers all of the surface of the stator constituted by the inner surface SI which delimits the axial receptacle of the associated rotor and the outer surfaces S1A, S1N of the first last plates 1a, 1 which constitute the set of plates 1.

The present invention also relates to a rotary electrical machine 20 comprising a stator 21 as previously described. FIG. 8 illustrates an embodiment of a rotary electrical machine of this type. This rotary electrical machine can be an alternator or an alternator-starter.

The rotary electrical machine 20 comprises a housing 22 inside which a rotor 23 is fitted integrally in rotation around the axis X of a shaft 24, and a stator 21 is fitted such as to surround the rotor 23 with the presence of an air gap.

The present invention has applications in particular in the field of rotary electrical machines for motor vehicles, but it can also be applied to any type of rotary electrical machine comprising a stator as previously described.

It will be appreciated that the foregoing description has been provided purely by way of example, and does not limit the field of the present invention, a departure from which would not be constituted by replacing the different elements by any other equivalents.

1. Stator, in particular of a rotary electrical machine for a motor vehicle, constituted by a plurality of plates (1a, 1b, 1c, . . . , 1n) forming a set of plates (1) with a generally cylindrical form, said stator having a plurality of radial notches (2), each notch being delimited by two adjacent teeth (3) which extend radially, and are connected to one another by means of their proximal end (3A), their distal ends (3B) defining a cylindrical axial receptacle which can receive a rotor, and being provided with tooth roots (4) constituted by projecting portions extending in the direction of the inner cavity of the notches, such as to reduce the width of the notch at its inlet, the notches being provided in their interior with a notch base insulator (5) covering the inner wall of said notches on the useful filling periphery of the conductive wires (F), and the stator comprising a plurality of flat notch closure wedges (6), wherein each notch closure wedge is arranged inside a notch, at a non-zero distance from the lower end of the notch base insulator.

2. Stator according to claim 1, wherein the lower part of each of the teeth (3) has a groove (7) which extends axially along the stator, between the lower end of the insulator (5) and the upper end of the tooth roots (4).

3. Stator according to claim 1, wherein the distance which separates the upper end of the notch closure wedge (6) and the lower end of the notch base insulator (5) is between 0.05 mm and 0.6 mm.

4. Stator according to claim 1, wherein the surface of the stator constituted by the inner surface (SI) which delimits the axial receptacle of the associated rotor and the outer surfaces (S1A, S1N) respectively of the first and last plates (1a, 1n) which constitute the set of plates (1) is covered with an insulating coating (RI).

5. Method for electrical insulation of a stator produced according to claim 1, the stator being constituted by a plurality of plates (1a, 1b, 1c, . . . , 1n) forming a set of plates (1) with a generally cylindrical form, and said stator having a plurality of radial notches (2), each notch being delimited by two adjacent teeth (3) extending radially, and being connected to one another by means of their proximal end (3A), their distal ends (3B) defining a cylindrical axial receptacle which can receive a rotor, and being provided with tooth roots (4) constituted by projecting portions extending in the direction of the inner cavity of the notches such as to reduce the width of the notch at its inlet, said method being characterised in that it comprises:
a step of insertion of a notch base insulator (5) in the notches, such as to cover the inner wall of said notches on the useful filling periphery of the conductive wires (F);
a step of putting into place a plurality of flat notch closure wedges (6), each notch closure wedge being arranged inside a notch, at a non-zero distance from the lower end of the notch base insulator.

6. Method according to claim 5, comprising a step of depositing an insulating coating (RI) on the surface of the stator constituted by the inner surface (SI) which delimits the axial receptacle of the associated rotor and the outer surfaces (S1A, S1N) respectively of the first and last plates (1a, 1n) which constitute the set of plates (1), such as to make up for the lack of insulation between the notch closure wedge (6) and the notch base insulator (5).

7. Method for electrical insulation according to claim 6, comprising a step of spraying an insulating coating (RI) constituted by an insulating paint of the organic resin type with good dielectric power, by means of a spraying device (P), which is designed to permit spraying of said insulating coating on all of the surface of the stator constituted by the inner surface (SI) which delimits the axial receptacle of the associated rotor and the outer surfaces (S1A), S1N) respectively of the first and last plates (1a, 1n) which constitute the set of plates (1).

8. Method for electrical insulation according to claim 6, comprising a step of spraying the insulating coating by means of a spray gun device secured on the end of an articulated arm, which makes it possible to displace the spray nozzle (B) of the spray gun device opposite each of the surfaces of the stator constituted by the inner surface (SI) which delimits the axial receptacle of the associated rotor and the outer surfaces (S1A, S1N) respectively of the first and last plates (1a, 1n) which constitute the set of plates (1).

9. Method for electrical insulation according to claim 6, comprising a step of spraying the insulating coating (RI) by means of two fixed spray nozzles (B1, B2) oriented such that their combined action covers all of the surface of the stator constituted by the inner surface (SI) delimiting the axial receptacle of the associated rotor and the outer surfaces (S1A, S1N) respectively of the first and last plates (1a, 1n) which constitute the set of plates (1).

10. Rotary electrical machine for a motor vehicle, comprising a stator according to claim 1.

11. Rotary electrical machine according to claim 10, forming an alternator or an alternator-starter.

12. Stator according to claim 2, wherein the distance which separates the upper end of the notch closure wedge (6) and the lower end of the notch base insulator (5) is between 0.05 mm and 0.6 mm.

13. Stator according to claim 2, wherein the surface of the stator constituted by the inner surface (SI) which delimits the axial receptacle of the associated rotor and the outer surfaces (S1A, S1N) respectively of the first and last plates (1a, 1n) which constitute the set of plates (1) is covered with an insulating coating (RI).

14. Stator according to claim 3, wherein the surface of the stator constituted by the inner surface (SI) which delimits the axial receptacle of the associated rotor and the outer surfaces (S1A, S1N) respectively of the first and last plates (1a, 1n) which constitute the set of plates (1) is covered with an insulating coating (RI).

15. Method for electrical insulation of a stator produced according claim 2, the stator being constituted by a plurality of plates (1a, 1b, 1c, . . . , 1n) forming a set of plates (1) with a generally cylindrical form, and said stator having a plurality of radial notches (2), each notch being delimited by two adjacent teeth (3) extending radially, and being connected to one another by means of their proximal end (3A), their distal ends (3B) defining a cylindrical axial receptacle which can receive a rotor, and being provided with tooth roots (4) constituted by projecting portions extending in the direction of the inner cavity of the notches such as to reduce the width of the notch at its inlet, said method being characterised in that it comprises:
a step of insertion of a notch base insulator (5) in the notches, such as to cover the inner wall of said notches on the useful filling periphery of the conductive wires (F);
a step of putting into place a plurality of flat notch closure wedges (6), each notch closure wedge being arranged inside a notch, at a non-zero distance from the lower end of the notch base insulator.

16. Method for electrical insulation of a stator produced according to claim 3, the stator being constituted by a plurality of plates (1a, 1b, 1c, . . . , 1n) forming a set of plates (1) with a generally cylindrical form, and said stator having a plurality of radial notches (2), each notch being delimited by two adjacent teeth (3) extending radially, and being connected to one another by means of their proximal end (3A), their distal ends (3B) defining a cylindrical axial receptacle which can receive a rotor, and being provided with tooth roots (4) constituted by projecting portions extending in the direction of the inner cavity of the notches such as to reduce the width of the notch at its inlet, said method being characterised in that it comprises:
a step of insertion of a notch base insulator (5) in the notches, such as to cover the inner wall of said notches on the useful filling periphery of the conductive wires (F);
a step of putting into place a plurality of flat notch closure wedges (6), each notch closure wedge being arranged inside a notch, at a non-zero distance from the lower end of the notch base insulator.

17. Method for electrical insulation of a stator produced according to claim 4, the stator being constituted by a plurality of plates (1a, 1b, 1c, . . . , 1n) forming a set of plates (1) with a generally cylindrical form, and said stator having a plurality of radial notches (2), each notch being delimited by two adjacent teeth (3) extending radially, and being connected to one another by means of their proximal end (3A), their distal ends (3B) defining a cylindrical axial receptacle which can receive a rotor, and being provided with tooth roots (4) constituted by projecting portions extending in the direction of the inner cavity of the notches such as to reduce the width of the notch at its inlet, said method being characterised in that it comprises:
a step of insertion of a notch base insulator (5) in the notches, such as to cover the inner wall of said notches on the useful filling periphery of the conductive wires (F);
a step of putting into place a plurality of flat notch closure wedges (6), each notch closure wedge being arranged inside a notch, at a non-zero distance from the lower end of the notch base insulator.

18. Method for electrical insulation according to claim 7, comprising a step of spraying the insulating coating by means of a spray gun device secured on the end of an articulated arm, which makes it possible to displace the spray nozzle (B) of the spray gun device opposite each of the surfaces of the stator constituted by the inner surface (SI) which delimits the axial receptacle of the associated rotor and the outer surfaces (S1A, S1N) respectively of the first and last plates (1a, 1n) which constitute the set of plates (1).

19. Method for electrical insulation according to claim 7, comprising a step of spraying the insulating coating (RI) by means of two fixed spray nozzles (B1, B2) oriented such that their combined action covers all of the surface of the stator constituted by the inner surface (SI) delimiting the axial receptacle of the associated rotor and the outer surfaces (S1A, S1N) respectively of the first and last plates (1a, 1n) which constitute the set of plates (1).
